(19) United States
(12) Patent Application Publication
(10) Pub. No.: US 2014/0247139 A1
(43) Pub. Date: Sep. 4, 2014

(54) ELECTRIC POWER CONSUMPTION, PIPELINED GAS OR WATER REAL TIME REMOTE MONITORING SYSTEM EMPLOYED IN INDUSTRIAL, COMMERCIAL AND HOME DISTRIBUTION NETWORKS, MANAGED BY POWER, GAS AND WATER CONCESSIONARIES

(71) Applicant: Ilario Bocaletto, Campinas Sao Paulo (BR)

(72) Inventor: Ilario Bocaletto, Campinas Sao Paulo (BR)

(21) Appl. No.: 13/576,657

(22) PCT Filed: Dec. 16, 2011
(86) PCT No.: PCT/BR11/00478

§ 371 Date: Aug. 2, 2012

(30) Foreign Application Priority Data
Nov. 21, 2011 (BR) PI 1105003-9

(51) Int. Cl. G01D 4/00

(52) U.S. Cl. CPC G01D 4/002
USPC 340/870.02

(57) ABSTRACT

As of invention patent, hereof represented by an inventive solution under the represented management concessionary sector for the distribution, commercialization of electricity, pipelined gas and water, internet and cable TV subscription services is provided. Notably as far as data collection, and individual consumption data processing (home, commercial and industrial) which once applied produces gains in terms of operational logistics, expressive cost reduction, notably manpower cost reduction, more reliability of the collected consumption data, also the possibility of real time consumption monitoring, enabling the efficient processing in due diligence of the accounts payable payments, as well as signaling the concessionary company on the consumption points, such as proprieties where there is excessive consumption of electricity, pipelined water and gas which is not in accordance with the previously defined home (2), commercial (3) and industrial (1) client profile for each property, at which each meter (4) is coupled with an individual consumption data translator/transmitter (9) that captures the consumption data transmitting it to a reception and retransmission center such as radiofrequency EDGE, optical fiber, PLC, ZigBee, satellite, 3G, 4G, LTE WiMax, PSTN, STFC, Z-Wave, Xbee, LAN or Mesh that communicates remotely with the management center (6) of the concessionary company (5). Using a programming microcontroller that through a magnetic field reading device which is induced by the electrical current, going through the AD converter, gauging it for measuring and ticketing procedures, and going next to the micro controller, sending data to the server through the sent module. The Server will then make the conversion and tariff procedures of the consumption real time, enabling the monitoring and a better expenditure control.

### FIELD OF THE INVENTION

This patent of invention under the heading of the title as above, that summarizes the invention and thus the object of description and claim in this title is an inventive solution that encounters highlighted benefits under the due represented sectors of the commercialization and distribution of electricity, pipelined gas, water, internet and TV subscription services clearly as far as data collection and processing of individual data Consumption (home, commercial and industrial.

### BACKGROUND

The generation, commercialization and distribution concessionaries of electric power, gas and water respectively, although related to different , distinctive products which demand processes and different logistics distribution among themselves, they represent a common point as far as such inputs' consumption control is concerned in each of these residential, commercial and industrial units where this process is carried out by consumption meter devices, commonly called clock meter or consumption reading

1. Under an economic perspective: considering the measuring and data processing systems of conventional water or gas, electricity inputs consumables consumptions, the inventor identified the imperative need of finding a significant operational cost reduction of this system, taking into account that such reduction goes from an enhanced allocated labor force cost reduction to the collection and data processing of the service consumption, along with internet and TV subscribing services distribution.

2. Under an operational perspective: with the exponential growth of urban areas, as well the growth of basic sanitation supply, electricity, water and sewerage to rural areas, it is now more urgent that there is possibly more agility in the individual collection and processing of consumption data systems, since the consumers must receive their bill due diligence in order to pay for the invoices issued on their names for the consumption of the services offered.

3. Under the perspective of the consumer safety: in times of unbridled crime growth in the country, lies the real fact that there the urgent need to eliminate theft or robbery in the installation buildings that have a way to stop the access of unknown not properly identified people such as the concessionaire services renders of electric power, water and sewerage, and gas distribution.

4. Under the perspective of the employee: there is the urgent need to reduce the accident rate of the concessionary company professionals that work in the Field, reducing thus the costs of labor claim nature, due to work leaves of the employee, injured in a work related accident.

5. Under the environmental concern perspective: considering that the relationship between renewable energy reserves or not versus the energy progressive use demands is increasingly critical, there is the urgent need to identify and stop all sources of wastes, decreasing thus greatly carbon dioxide emissions, since it will reduce thermoelectric plant activities that use fossil fuels at its operations.

6. Under the social perspective: considering that internet is the most powerful communication means with the greatest growth rate in the world, however not accessible to all social levels, due to its costs and the lack of necessary infrastructure for its dissemination, the system will create the concept called “internet to all”.

7. Under the perspective of advantages: Through a very reliable and precise system, the payment of bills can me made totally online, generating thus savings not under the financial aspect only, but also avoiding the use of papers in the issuing process of the invoices, therefore making things easier for the consumer in terms of agility, quickness and savings, having a pre paid differentiated system that the consumer has the option of paying his electricity, water, gas and internet and TV subscription services before using them.

### SUMMARY OF THE INVENTION

In line with the invention's demand and paradigm, the applicant idealized an unprecedented electric power consumption, pipelined gas or water, real time remote monitoring system employed in home, commercial and industrial distribution networks, managed by electric power, gas and water concessionary companies provided with an inventive activity associated novelty since it is not the result of obvious or evident manner of other known solutions under the state of art as for the conventional individual consumption data collection and processing system of electric power, gas and water.

Moreover, the “invention” is provided with industrial applicability, since it involves use of economic technology, being feasible in this regard and therefore meeting strict patent requirements, notably as patent of invention.

Aiming at enabling veracity to the detailed context, a brief explanation will be presented on the introduction on the state of the art for the electric power, applied gas, water, internet, cable TV subscription consumption conventional monitoring system in urban distribution networks or rural areas, where a specialized technician in the subject will be able to recognize its limiting aspects so that in the future the added advantages related to the introduction of the new real time monitoring system will be dully discussed.

### The State of the Art

The sales and distribution concessionaries of electricity, pipelined gas, and water have employed a great deal of infrastructures so that its distribution meets the needs of the greatest number of consumers as possible, which are classified under three great sectors: home, commercial, and industrial, where such infrastructure has to cover the urban area, as well as the rural areas of all municipalities which are under its service coverage.

While pipelined gas, even water, and electric power supply is characterized as constant, in other words, there is no intermediation between the distribution center and the consumption point itself, the same does not occur for the consumption data collection system of each unit's consumption.

This way, in contemporary times, it is mandatory that the precise reading of the consumption meters is carried out in each of the points served, and for this the recruiting and placement of professionals is necessary, aiming at conducting the reading at each meter, as well as in case of power connection or disconnection.

In more recent times a great development was experienced in the areas of collection and consumption report generation, preliminarily registered in the meters, where the professional with an automated device registers the consumption reading of a certain meter directly in a database which structure is previously defined by means of an application software. At the end of a working day, the professional goes to the concessionary center and unloads the collected data in the management system that controls the consumption, consumption reports generation and the consumption value to be paid by each consumer. Alternatively there are devices that have employed a data transmission module via radio, indicated to any type of mobile communication technology and it can even be carried out by sending data in a MMS protocol which in this case, the data collected by the professional is sent directly to the concessionary consumption center management.

Problem identification: Although the current collection/reading system of water, pipelined gas or electricity is efficient, it brings along a number of negative aspects such as:
The high cost employed, since it requires a great deal of man power for the reading procedure work in homes, commercial and industries establishments. As an example, it is important to appoint at least a service render in the field in order to make the consumption reading of pipelined gas and water and electricity of 300 units possible, which leads us to a globalized demand for workers, in Brazil alone a demand of about eighty thousand workers (direct or indirect);
The reliability of the data measured is totally dependent on a visual reading, therefore subjected to mistakes that if added to the total contingent nationally wise represent a significant reading deviation;
The private safety is affected, since the presence of a service render inside a propriety to carry out the reading in the consumption meters creates a gap in the safety of the access to the premises of the propriety;
The consumption reading service renders are exposed to work accidents considered as labor related accidents, that which occurs from the moment which the worker leaves his home until going back home at the end of his shift, creating thus a high cost in terms of the contracted life insurance to each employee and specially for those who face great life risks by connection or disconnecting power directly from high voltage pylons;
From the collected consumption data processing perspective, it is verified that the individual collected data as for each measuring meter unit no longer meets the exponential growth demands of new proprieties and consequently new points of consumptions; becoming thus a bottleneck in terms of issuing management of the bills to be forwarded to the concessionary service users;
The reading of the meters is carried out as for a matter of cost, only once a month, which makes impossible abnormal consumption detection in certain meters which in reality would characterize a loss/robbery source/of electricity, pipelined gas and water, increasing the losses to the consumers in terms of the further away from the data reading date of the meter, the electricity, gas, or water deviation and/or loss may occur.

As it seen according to the identified and highlighted problems, it can be affirmed that such occurs fundamentally due to the manual concept of conventional consumption measuring collection system of electricity, pipelined gas and water, based upon the imperative need of the use of labor force in the field, in other words on the streets, which makes such procedure inclined to be slow and to have a compromised reliability. Moreover, it is impossible at this conventional system the irregular consumption identification, notably when compared to the previous month consumptions. However, the electricity concessionary and consequently the customer will only notice such irregular aspects and consequent loss when such have become lengthy and complicated.

Referring now to the present invention, the applicant, being aware of the gap in the current manual data consumption collection system of electricity, pipelined gas and water, proceeded with the development of an inventive solution in the format of a real time monitoring electricity, pipelined gas and water, internet and cable TV subscription service consumption data collection from which the following are described as embodiments of the present invention:

Significant allocated field man power cost reduction in terms of service renders for the consumption reading procedures, carried out in homes, commerce and industry, positively impacting in the service rendering cost composition of distribution and commercialization of this type of input. Attention must be given to the fact that the concessionary companies must have a future plan as to the occupational reallocation of the professionals that will be removed from the streets, enabling new working opportunities to these individuals, thus reducing the so called unfounded displacement, in which the concessionaries have a high cost, by keeping technicians always available in case there is any electric power failure.

Implementation cost reduction of the new real time monitoring system, where the precise installation of data reading and remittance device of electricity, pipelined gas and water consumption, in time and alongside the meter that is paid during the first months of the implantation and mainly forthcoming from the savings, presents an easy and fast way of installation with a great differential, since it is a hybrid equipment which makes it work independently, having a battery that saves the information for days and it stands a temperature up to 90 degrees Celsius.

Special real time agility, online accounts payable bill issuing process, or via telephone by the input consumptions of electricity, pipelined gas and water as well as the issuing of comparative statements and consumption reports, compared to the previous month expenditure as performed currently, thanks to the fact that the management system of the concessionary works with a database of all consumption of meters registered and connected to this monitoring and inventive system. Besides the agility of online bills, this system has total interaction with the consumer through various communication means, from internet up to SMS (mobile phone system) and also with the differential of the prepaid system, which allows the consumer to pay the electricity, before actually using it, having the payment made as a credit, through an intelligent system that identifies such credit, before being used, thus informing the consumer.
Electricity, gas and water can be easily connected or disconnected from the central operations, reducing operational costs, aiming at safety and practicality and not having to expose the lives of employees to danger in the case of high voltage pylons for example;
The total reliability of an intelligent dual chip data transmission system, which allows a high rate of safety as far as spare equipments or failure proof back up, presenting thus total reliability in case of loss or consumption data transmission failures.
Electricity, pipelined water and gas irregular consumption identification, according to individual consumption for each meter, connected to this inventive monitoring system, in such a way that as soon as the problem is detected, the consumer is alerted, and a visit can be scheduled by the concessionary for the maintenance of the measuring equipment or even the indication of the problem so that the consumer is able to identify and solve the due causes of the irregular identified consumption. Such irregularity problems are not only related with the electricity outcome but also with the a loss in the quality of electricity which is considered as irregularities and which will not take the consumer by surprise with a high consumption bill of electricity, pipelined water and gas.
Efficiency when it comes to consumption follow up, since the system informs the KW/h kilowatt hour), reactive power, active power and the outcome value according to the country currency, which makes the seasonal hour tariff collection easy, as well as the differentiated hour tariff, logically generating a great savings not only in the visual monetary values but also bringing forth a great savings in electricity and the integration with various communication systems and intelligent electricity networks, such as smart grid, showing a greater and better savings, hence enabling the consumer to visualize what is being consumed.
Internet and cable TV subscription service transmission made by a highly precise and reliable system, enabling accessibility in the utilization of these services for those who do not have access to it yet.

Distinctive feature: in order to make the listed predicates possible with the introduction of the electric power, pipelined gas and water consumption real time monitoring system, the device was idealized as from the introduction of an automated reading meter device (digital or analogical) set in the meter where it accesses real time the inputs' consumption reading process.

Conceptually, the consumption data of the meter device of the input are processed and transformed into digital data that in return, it goes through a second conversion, transforming themselves into radio signals, that by means of an antenna device and signal emission are sent therefore to a reception remote station and data retransmission, ensuring the origin dully identification (and consequently of the meter) as of each of the signals captured, being then retransmitted to the data capture center.

The capture data center is directly connected to the consumption management meter network of the concessionary service, such as electricity and pipelined gas, where there is the consumption data management system, traditionally applied in contemporary times.

The great differential in this case is that a new routine to provide real time consumption monitoring can be added to the traditional consumption data management system as of each meter, also enabling the option of connecting or disconnecting the power, not having the displacement of a field team to carry out the work, even in case of tens, hundreds and thousands of miles away from the concessionary center. Thanks to such routine, warnings can be sent upon consumption profile changes, previously defined as for each consumption meter, which is a part of the concessionary's meter networks.

### BRIEF DESCRIPTION OF THE DRAWINGS

As to completing the current descriptive report, aiming at obtaining a better understanding of this patent of invention, a set of layout drawings is enclosed to this document which reproduce the conventional data consumption collection and following presented, a layout drawing set of the accomplishment of a chosen real time monitoring system for the consumption of electricity, pipelined water and gas, in home, commercial, and industrial distribution networks managed by power, gas and water concessionaries which:

FIG. 1 is the schematic layout representation of the conventional electricity, pipelined gas and water distribution layout system employed by concessionaires;

FIG. 2 is the schematic layout representation of the conventional electricity, pipelined gas and water distribution layout system, employed by the concessionaires, highlighting a macro vision of the consumption data collection, notably a manual collection;

FIG. 3 is the schematic layout representation of the conventional electricity, pipelined gas and water distribution layout system, employed by the concessionaires, highlighting a micro vision of the consumption data collection system, notably a manual collection;

FIG. 4 is the schematic layout representation of the electricity, pipelined gas and water consumption real time remote monitoring system, applied in home, commercial and industrial distribution managed by concessionaries under a first format of the conducted operations in which the system addresses the use of EDGE technology (Enhanced Data Rates for GSM Evolution) as of transmission and retransmission of data directly to the management.

FIG. 5 is the schematic layout representation of the real time remote monitoring system of the electricity, pipelined water and gas employed in home, commercial and industrial distribution managed by gas and water concessionaries under a second format of the conducted operations which the referred system addresses the use of transmission and retransmission of data by radio frequency technology;

FIG. 6 is the schematic layout representation of the real time remote monitoring system of electricity, pipelined water and gas consumption employed in home, commercial and industrial distribution networks, managed by concessionaries in a systems' operation micro vision; and

FIG. 7 is the schematic representation of the analogical/digital reading post processor from consumption data to digital data and eventual conversion into individual signal of radiofrequency, EDGE, optical fiber, PLC, ZigBee, satellite, EG, 4G, LTE WiMax, PSTN, STFC, Z-wave, Xbee, LAN or Mesh, which makes the remote system possible, thus the object of reinivindication.

### DETAILED DESCRIPTION

The following detailed description should be read and interpreted with reference to the represented drawings, which do not limit the scope of the invention.

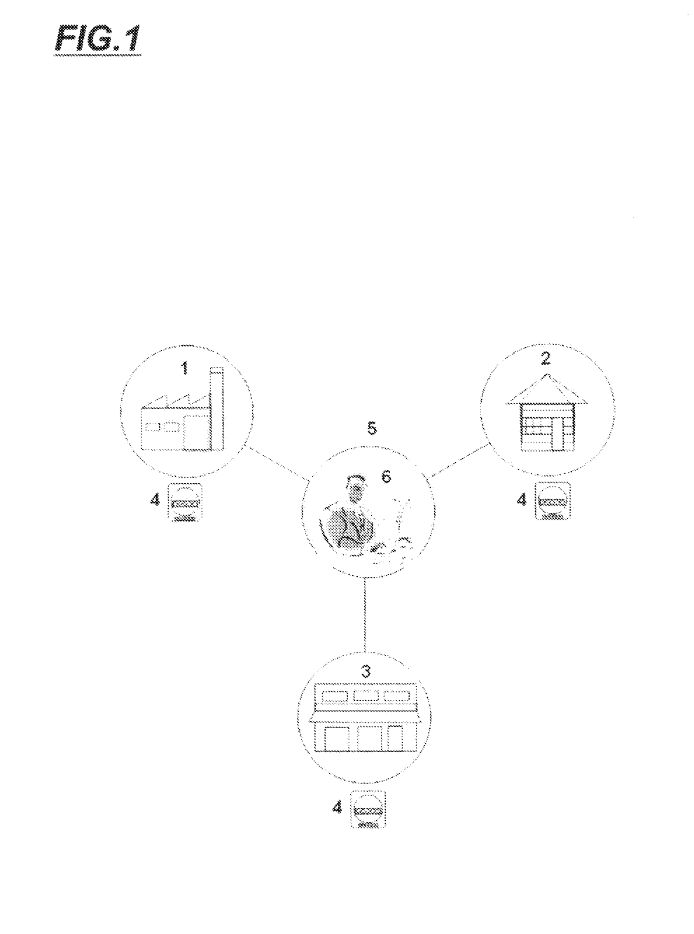

As of the highlighted state of the art: aiming at making the demand understanding easier, as well as the differentiation of the invention, through FIG. 1 the conventional system layout for electricity, pipelined gas, and water distribution is revealed which is applied by the concessionaries which clearly finds its application field (5) and where the management center is defined (6) to which home, (2) industrial (1) and commercial (3) proprieties are virtually connected and physically connected to the respective consumption meters. (4).

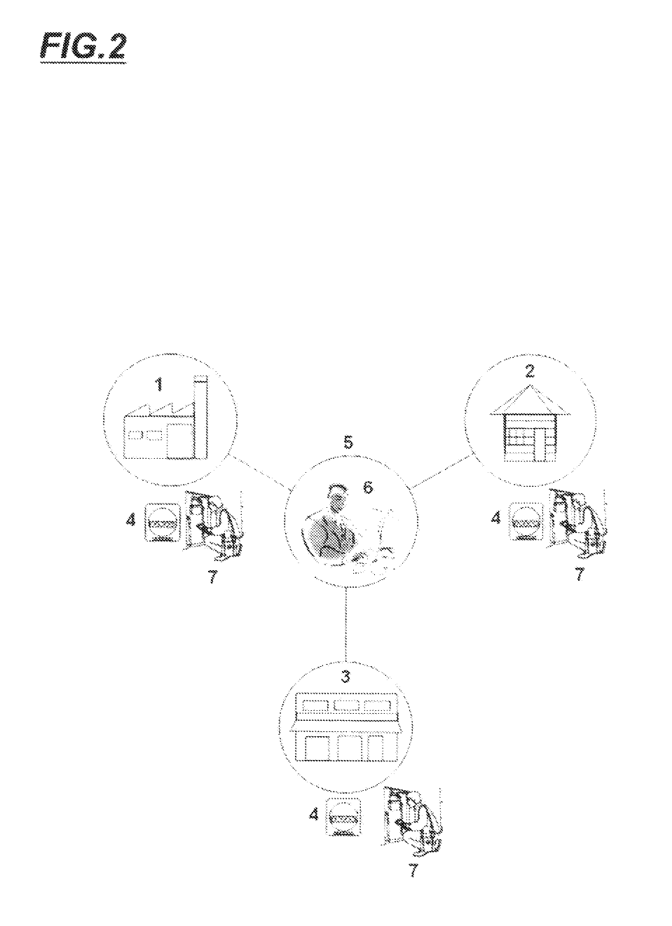

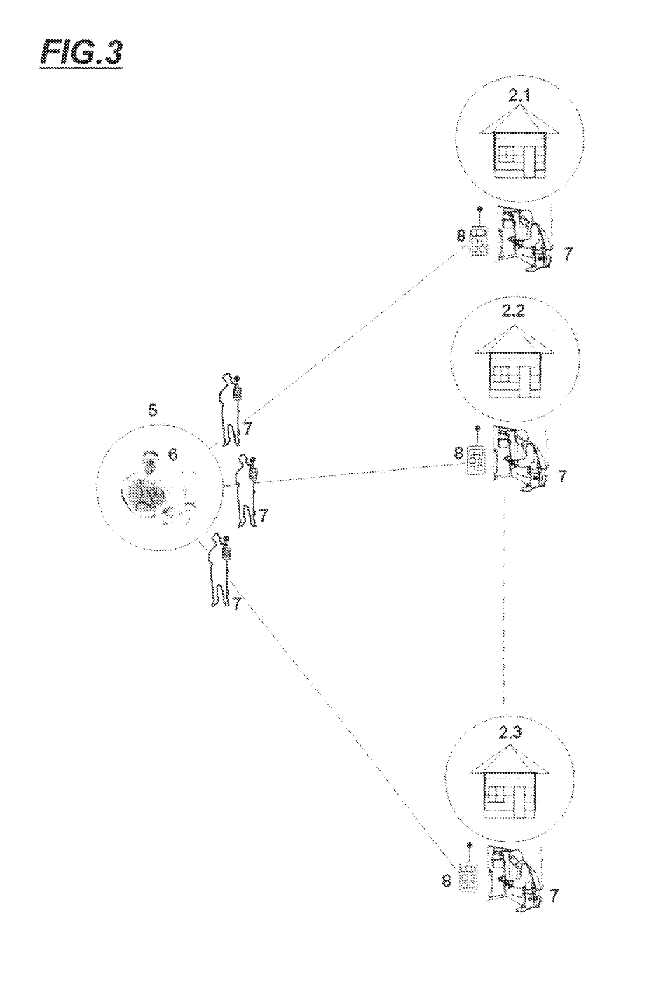

On the other hand, the consumption data collection system of electricity, pipelined gas and water is made in a manual manner through the displacement of the service render employee (7) that conducts the individual reading procedure of each meter (4) which data are registered in an automated database device (8), as highlighted through FIGS. 2 and 3 respectively, being then unloaded or not remotely in the management center (6) of the concessionary (5). Such applied logistics brings along the negative aspects exhaustively highlighted under the bases of the technique, previously analyzed.

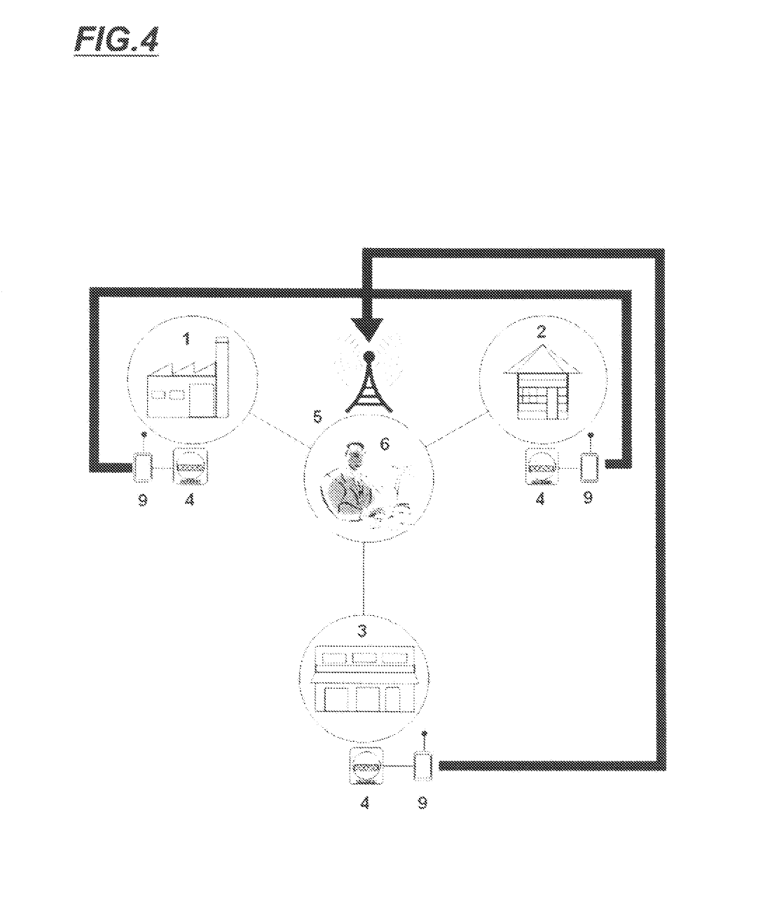

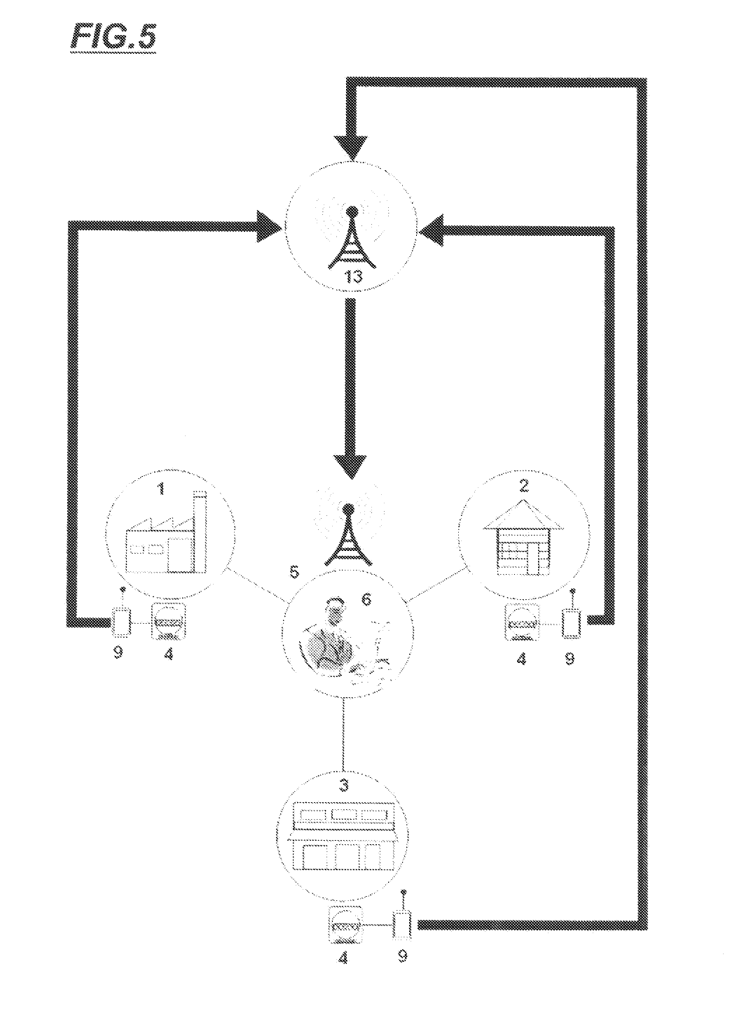

As of the revealed invention: the unprecedented system of electricity, pipelined gas and water consumption real time remote monitoring complies to the same conventional distribution system of electricity and pipelined gas and water applied by the concessionaires are highlighted in FIG. 1. However, such system is different from the conventional data collection one as for electricity, pipelined water and gas consumption data, since it introduces an unprecedented individual data consumption translator and transmitter device (9) which substitutes the service render (7) as well as the database automated device (8) as highlighted through FIGS. 4 and 5 in a system's macro vision.

This time, taking FIGS. 4 and 5 respectively as reference, it is possible to understand the unprecedented individual consumption, real time monitoring system as being formed by the concessionary (5), with its corresponding management center (6), that has a distribution network made up by home (2), commercial (3), industrial (1) proprieties which are supplied electricity, pipelined water and gas. In this case, the physical connection with the inputs' generation center is kept and measured by the consumption meters (4).

For its part, the individual (9) data consumption translator and transmitter devices are coupled to the consumption meters (4), that translates the analogical or digital reading into a digital information and are subsequently transmitted to a data reception and retransmission remote station via radiofrequency, EDGE, optical fiber, PLC, ZigBee, satellite, 3G, 4G, LTE WiMax, PSTN, STFC, Z-Wave, Xbee, LAN or Mesh, as in FIG. 4, such as a data reception and retransmission tower (13), as in FIG. 5.

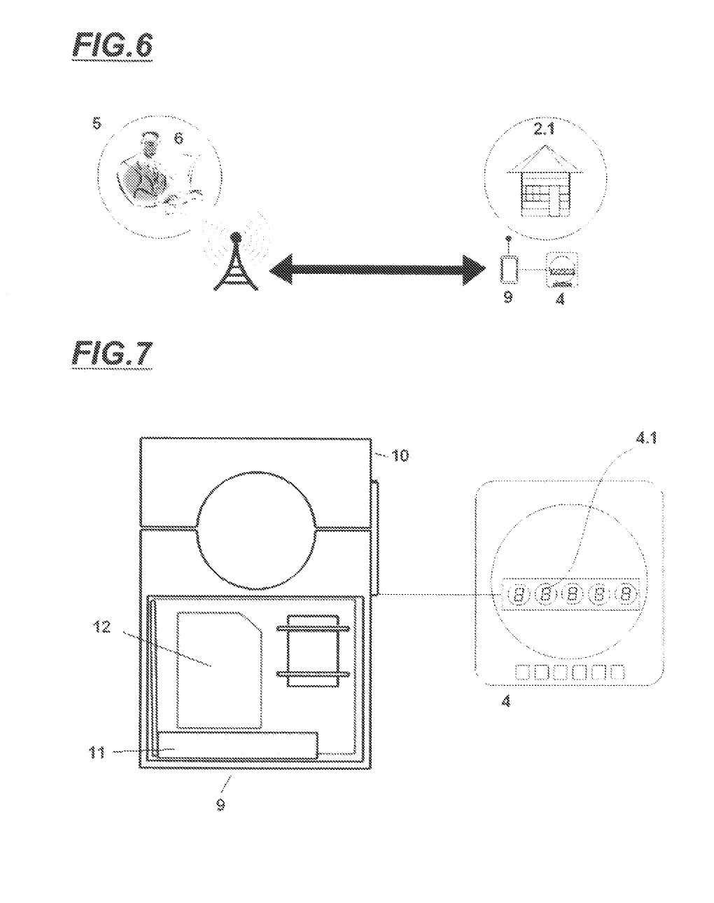

On the other hand, this remote reception and retransmission tower retransmits data to the concessionary (5), that in turn begins to count with a reception server which is relevant to highlight that the consumption data reception and transmission occurs real time, without interruption for which this functional logic is highlighted through FIG. 6 and it also retransmits the management (6) needed information to (2.1)

Data translator/transmitter device (9): Just as highlighted by FIG. 7, its constructive concept is made up essentially by a printed circuit board (11) and a data translator (19) which is assembled inside the housing (10) that presents a transmission antenna (12), a power source (14) a relay (15) and a display (16). From the operational understanding perspective, the printed circuit board (11) is connected directly to the meter measuring mechanism (4.1) that has an analogical or digital technology defined in the meter (4), in such a way that at each consumption update, it is immediately processed and interpreted by the printed circuit board (11). This digital consumption data is transmitted via a transmission antenna (12) to a data reception and retransmission remote station, which subsequently retransmits the data to the management center (6) of the concessionaries (5). Power supply is carried out by the line (17) that then starts to be measured and leaves the charge (18)

Practical result: it is possible to have a complete vision or even an individualized one in terms of the proprieties' consumption conditions that are a part of the customers network of a certain concessionary, ensuring then the immediate issuing of payment batches, as well as the identification of the proprieties with consumption excess problems and the remote connection and disconnection of both.

The choice regarding the type of accomplishment of the invention, here as the object of a claim in this writing, detailed on this descriptive topic is supplied only as an example. Alterations, changes, and variations may be made as for any other accomplishment types of real time remote monitoring system with those of skill in the art, however, not deviating from the revealed objective of this invention.

1-5. (canceled)

6. A real time remote monitoring system of one or more of electricity, pipelined gas and water consumption comprising:
(a) a distribution system for one or more of electricity, pipelined water or gas,
(b) a management center,
(c) a network of homes, commercial and industrial properties connected to said management center, and
(d) one or more consumption meters at one or more points within said network, wherein real time remote monitoring is provided by a data translator and data transmitter coupled to each of the consumption meters that communicates remotely with a data reception and retransmission remote station, said remote station communicating with said management center.

7. The system of claim 1 wherein the data translator and data transmitter comprises a printed circuit board assembled inside a housing compartment, and provided with a transmission antenna, where said printed circuit board is connected to the measuring mechanism of the meter and connected to the transmission antenna.

8. The system of claim 2 wherein the printed circuit board post-processes analog or digital data received from a measuring mechanism, and then outputs digital data to a transmission antenna which transforms the digital data into a radiofrequency signal.

9. The system of claim 1 wherein the management center receives consumption data in real time without interruptions and sends information to input connection and disconnection.

10. The system of claim 5, wherein real time monitoring is characterized by a specific routine within the management center application software.

11. The system of claim 9, wherein real time monitoring is characterized by a specific routine within the management center application software.
